(19) United States
(12) Patent Application Publication
(10) Pub. No.: US 2006/0045436 A1
(43) Pub. Date: Mar. 2, 2006

(54) Low electromagnetic interference (EMI) shielded assemblies for electro-optical devices

(76) Inventors: Charlie Xinqiao Wang, Albuquerque, NM (US); David Bossert, Albuquerque, NM (US)

Correspondence Address: EMCORE CORPORATION, 1600 EUBANK BLVD, S.E., ALBUQUERQUE, NM, 87123, US

(21) Appl. No.: 10/925,847

(22) Filed: Aug. 26, 2004

(51) Int. Cl. G02B 6/36

(52) U.S. Cl. 385/92

(57) ABSTRACT

In an optical transceiver and/or receiver for converting and coupling an information-containing electrical signal with an optical fiber, an opto-electronic subassembly including an opto-electronic device for converting between an information-containing electrical signal and modulated optical signal corresponding to the electrical signal; and a Faraday shield for minimizing electromagnetic interference entering or leaving the opto-electronic device, extending adjacent to and around the portion of the connector adapted to couple to the periphery of the optical fiber.

### BACKGROUND OF THE INVENTION

1. Field of the Invention

The invention relates to transmitter and receiver subassemblies for use in optical transceivers, and in particular to electromagnetic interference shields in such subassemblies.

2. Description of the Related Art

Optical transceivers used in optical fiber communications systems use a transmitter optical sub-assembly (TOSA) to convert the electrical signal to an optical signal for data transmission, and a receiver optical sub-assembly (ROSA) to convert received optical signal back into an electrical signal. The TOSA or ROSA is typically manufactured by optically aligning an OSA barrel (or “OSA support or housing”) with an opto-electronic (OE) device package such as a TO (transistor outline) can to form the sub-assembly.

The TOSA or ROSA typically also includes an optical lens formed either inside the OSA barrel or on top of a device package such as a lens TO cap. Mounting an optical lens on the device package requires a high degree of precision in device package design in order to attain desired performance, which results in manufacturing difficulty and higher cost. For that reason, the optical lens is typically mounted on OSA barrels.

Two types of materials, namely, plastic and metal, are currently used to fabricate OSA barrels. The plastic part is made using a precision injection molding technique that enables tight tolerances and complex lens designs (e.g., aspherical lenses) to be integrated in the barrel for efficient fiber coupling. Epoxies are used to assemble the barrel with the device package to form a TOSA or ROSA. Metal-based barrel is constructed by machining using hard metal material such as stainless steel. It is then either epoxied or laser-welded to the device package to form a TOSA or ROSA. Optical lens is either installed on a TO can, or is snapped on manually to the metal barrels so that a TO can with a flat window can be used. In both cases, the optical lenses are typically simple ball lenses due to manufacturing limitations. The uncorrected image aberrations from the simple ball lenses will cause poor optical coupling and degrade TOSA and ROSA efficiency.

As any other device operating in the RF frequency range, transceivers based on opto-electronic devices generate significant electromagnetic interference (EMI), and also are very vulnerable to EMI from external sources. Typically, EMI generated from an RF source goes to all directions. The EMI between receiving and transmitting circuits in the same transceiver, which is referred herein as side EMI, causes significant device cross-talks and therefore degrades device performance. In addition, the EMI emitted through the front of a transceiver, which is referred herein as front EMI, affects the surrounding electronic environments. Transceiver designers typically try to reduce the EMI by shielding the RF sources, for example, by enclosing the transceiver in a grounded metal housing.

There are a number of references that describe implementation of the metal housing for transceivers, including U.S. Pat. No. 4,840,451 entitled “Shielded Fiber Optic Connector Assembly” and U.S. Pat. No. 6,483,719 entitled “Conforming Shielded Form for Electronic Component Assemblies.” However, they disclose using a large opening at the front end of the transceiver in order to allow external fibers to access the TOSA and ROSA. These large openings may not be major EMI concerns for low speed transceivers, but it is of an important concern for higher speed transceivers such as those operating at 10 Gigabits per second (Gbps) and beyond.

The non-conductive nature of the plastic OSA barrel poses a significant difficulty for transceiver designers to reduce EMI, especially for front EMI emanating in the direction where the optical fiber is coupled to the assembly. This is because transceivers typically rely on OSA barrels to connect to optical fibers for data transmission. Metal-based OSA barrels can solve this problem, but typically are comparatively more expensive. Further, it is generally more difficult to incorporate a complex optical lens (e.g., custom design optics) into the metal barrel as discussed above. A ceramic ferrule is typically also needed for the metal barrel due to the high precision requirement for fiber insert (within +/−2 micron) and it is very expensive for metal barrels to be machined with that precision.

Therefore, it is desirable to provide an apparatus and method for reducing front EMI of an OSA, especially when a plastic barrel is used, other than the grounded metal housing having a large opening as described above. It is also desirable to provide an apparatus and method to reduce side EMI of the OSA to reduce cross-talks, which tend to degrade device performance.

### SUMMARY OF THE INVENTION

Briefly, and in general terms, the present invention provides an optical transceiver and/or receiver for converting and coupling an information-containing electrical signal with an optical fiber, including an opto-electronic subassembly having a housing including an optical fiber connector adapted for coupling with an external optical fiber for transmitting and/or receiving an optical communications signal; and an opto-electronic device in the housing for converting between an information-containing electrical signal and modulated optical signal corresponding to the electrical signal. More particularly, the invention provides a Faraday shield for minimizing electromagnetic interference entering or leaving the opto-electronic device, extending adjacent to and around the portion of the connector adapted to couple to the periphery of the optical fiber.

In an exemplary embodiment of the present invention, an optical subassembly (OSA) includes an opto-electronic (OE) device, and a barrel for optically aligning the OE device with an external device. A metal shield is disposed between the OE device and the barrel so as to reduce the electromagnetic interference (EMI) of the OSA between the opto-electronic device and other circuitry in the optical transceiver. The metal shield has an aperture for allowing an optical beam to pass through. The aperture is positioned proximately to the focal point of the lens associated with the OE device, so that the size of the aperture can be minimized, thereby increasing the amount of shielding. Such reduction to the aperture size is highly desired for higher speed transceivers such as those operating at high speeds such as 10 Gbit/s. The OE device may be a photodetector, for example.

In another exemplary embodiment of the present invention, an optical transceiver includes a metal housing and an OSA mounted on the metal housing. The OSA includes an OE device, and a barrel for optically aligning the OE device with an external device. A metal shield is disposed between the OE device and the barrel so as to reduce the front EMI of the OSA. The metal shield has an aperture for allowing an optical beam to pass through. The aperture is positioned proximately to a focal point of the associated lens, so that the size of the aperture can be minimized. The OE device may be a photodetector, for example. The optical transceiver may also include a second OSA, which includes an OE package having a second OE device and a metal case containing the second OE device. The optical transceiver may further include a printed circuit board (PCB) having a PCB ground. The metal case is electrically coupled to a metal housing of the optical transceiver, so as to reduce side EMI within the metal housing. The second OE device may be a laser, for example.

In yet another exemplary embodiment of the present invention, an optical transceiver includes an OSA including an OE package having an OE device and a metal case containing the OE device. The optical transceiver also includes a printed circuit board (PCB) having a PCB ground, and a metal housing for holding the OSA and the PCB. The metal case is electrically coupled to the metal housing, so as to reduce side EMI within the metal housing. The OE device may be a laser, for example.

### BRIEF DESCRIPTION OF THE DRAWINGS

FIG. 1 is a perspective view of an optical transceiver in an exemplary embodiment in accordance with aspects of the present invention;

FIG. 2A is a perspective view of a hybrid optical sub-assembly (OSA) in another exemplary embodiment of the present invention;

FIG. 2B is a partially unassembled view of the hybrid OSA of FIG. 2A.

FIG. 2C is an OSA of the optical transceiver of FIG. 1;

FIG. 3A is a front view of the OSA of FIGS. 1 and 2.

FIG. 3B is a cross-sectional view taken along the line A-A of the OSA of FIG. 3A;

FIG. 4A is an OSA in an alternate exemplary embodiment in accordance with aspects of the present invention;

FIG. 4B is a metal plate in the OSA of FIG. 4A;

FIG. 5A is a front view of the OSA of FIG. 4A;

FIG. 5B is a cross-sectional view taken along the line A-A of the OSA of FIG. 5A;

FIG. 6 is a rear view of a conventional transmitter optical sub-assembly (TOSA);

FIG. 7 is a cross-sectional view taken along the line C-C of the conventional TOSA of FIG. 6;

FIG. 8 is a rear view of a conventional TO-46 package; and

FIG. 9 is a rear view of a TO package in an exemplary embodiment in accordance with aspects of the present invention.

### DETAILED DESCRIPTION

The present invention addresses the high EMI problems of current plastic-based optical sub-assembly (OSA), such as transmitter OSA (TOSA) and receiver OSA (ROSA), that are particularly important for high date rate applications. One exemplary embodiment in accordance with the aspects of the present invention provides a method and apparatus to provide a ground shield for the TOSA and ROSA to reduce the EMI to the outside of an optical transceiver. In another exemplary embodiment according to the present invention, a modified opto-electronic (OE) device package (e.g., TO can) for reducing EMI inside the transceiver is provided. Such modified OE device package should reduce cross-talk within the transceiver. These embodiments may be used either individually or jointly to realize superior EMI performance for TOSA and/or ROSA products without significantly increasing cost.

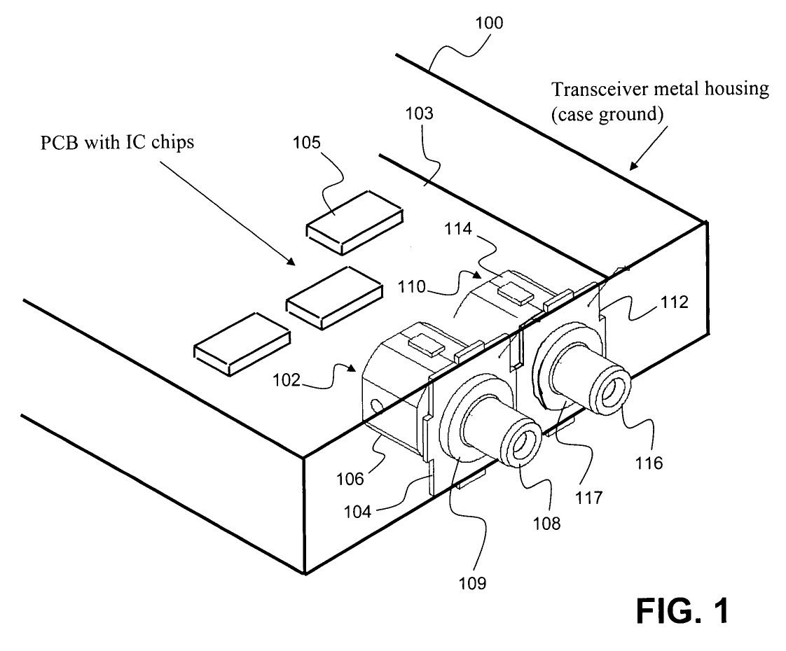

FIG. 1 is an optical transceiver in an exemplary embodiment in accordance with aspects of the present invention. The optical transceiver includes a printed circuit board (PCB) 103 and one or more integrated circuit (IC) chips 105 mounted thereon for processing the transmission and reception of optical communication signals.

The optical transceiver has a metal housing 100, which provides case ground (or chassis ground), for example. The metal housing 100 has mounted thereon optical sub-assemblies (OSAs) 102 and 110. For example, the OSA 102 may be a TOSA and the OSA 110 may be a ROSA, or vice versa. It should be noted that even though the optical transceiver as shown in FIG. 1 has a single TOSA and a single ROSA for a single-channel, serial transceiver, transceivers in other embodiments may include multi-channel, parallel optical transceivers with multiple ROSAs and/or multiple TOSAs.

The OSA 102 includes a metal plate (or a metal insert) 104 disposed between a housing 106 and a barrel 108. An OE device package is disposed within the housing 106. Of course, the OE device package may be an optical transmitter or receiver depending on whether the OSA 102 is a TOSA or a ROSA.

The metal plate 104 serves as a shield to reduce the front EMI emanating from the OE device package to outside of the metal housing 100. In other embodiments, the metal shield may have any suitable shape and may not necessarily be a plate. By way of example, the metal shield for reducing the front EMI may be any suitable bent piece of metal, a metal collar or a metal mesh with small grid. In still other embodiments, the metal shield may be formed by metal plating a non-metal material having a suitable size, shape and properties.

The barrel 108 has a flange 109 typically used to secure the OSA 102 on the metal housing 100. The metal plate 104 is held in place between the barrel 108 and the OSA housing 106. The barrel 108 is accessible from outside of the metal housing 100 in the exemplary embodiment. In the exemplary embodiment, the OSA housing 106 and the barrel 108 are formed from plastic. In other embodiments, the housing and barrel may be formed from other suitable materials.

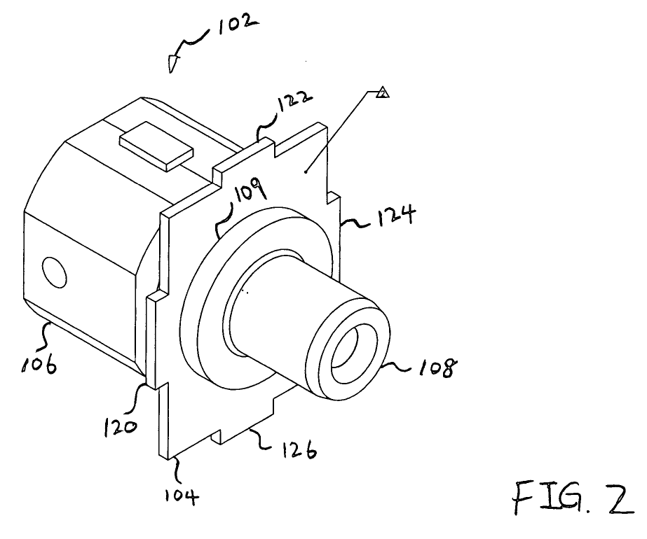

In other embodiments, as shown in FIGS. 2A and 2B, a hybrid OSA barrel 180 has a metal portion 184 which is near the metal housing 100 and a plastic portion 182 affixed to the metal portion 184, such that the metal portion of the barrel and the plastic portion of the barrel are affixed to one another (e.g., through gluing or any other suitable method) to form a single barrel. The metal portion 184 in and of itself may be referred to herein as a barrel, and the plastic portion 182 may be referred to as a body or a housing. The plastic portion 182 may also be made of any other suitable non-metal material.

When the metal portion 184 of the hybrid barrel 180 is connected electrically to the transceiver metal housing 100, the metal portion 184 shields an external device from the front EMI generated by the OE device package. Therefore, an additional metal shield, such as the metal plate 104, may not be needed.

In more detail, the metal portion 184 has a generally cylindrical member (“barrel”) 186 having an opening 187 for aligning the OE device inside the barrel 180 to an external device. The metal portion also has a flange 188 and a number (e.g., four) of feet 190 for engaging the metal housing 100. By way of example, the wall surrounding the opening (for mounting the hybrid barrel 180) of the metal housing 100 may be fitted between the flange 188 and the feet 190. The aperture (not shown) in the metal portion 184 for passage of the optical signal should be close to the focal point of the optical signal passing through the barrel such that the aperture can be made as small as possible (i.e., the size of the aperture can be minimized). By way of example, the aperture may be 1 mm or less (e.g., 0.2 mm) in diameter.

The OE device is disposed inside the plastic portion 182. The plastic portion 182 has a generally box-like housing 192 and a substantially cylindrical barrel 194 protruding therefrom. The cylindrical barrel 194 has an opening 195 formed thereon for allowing an optical signal to pass through. The surface of the feet 190 facing away from the flange 188 is mounted on a surface 196 of the box-like housing 196, and is attached (e.g., via gluing) thereto.

In other embodiments, the barrel may have a thin metal layer plated/coated over. The metal coating provides an EMI shield when it is connected electrically to the transceiver metal housing 100. For the same reason, an additional metal shield, such as the metal plate 104, may not be needed.

The OSA 110 is substantially the same structurally as the OSA 102 except that the OE chip package installed within the OSA 110 includes an optical receiver (e.g., a photodetector) as opposed to the optical transmitter (e.g., a laser) installed within the OSA 102. Similar to the OSA 102, the OSA 110 includes a housing 114, a metal plate 112 and a barrel 116, where the OSA housing 114 and the barrel 116 may be formed of plastic or any other suitable material. The barrel 116 has a flange 117 typically used to secure the OSA 110 on the metal housing 100. The barrel 116 is accessible from outside of the metal housing 100 in this exemplary embodiment.

FIG. 2C is an enlarged view of the OSA 102 of FIG. 1. Since the OSA 110 is substantially the same structurally as the OSA 102, only OSA 102 will be discussed hereinafter with the understanding that the description applies equally as well to the OSA 110, except that OSA 102 includes an optical transmitter (e.g., laser) in the OE device package while the OSA 110 includes an optical receiver (e.g., photodetector).

In the described exemplary embodiment, the metal plate 104 has a substantially rectangular shape, and has formed thereon a protruding member (i.e., a step) about the middle of each side (i.e., each edge) of the rectangle. Each of the protruding members 120, 122, 124 and 126 is substantially rectangular in shape, length of its longer side is approximately one third the length of the respective side from which it protrudes, and is substantially parallel to the respective side. One or more of the protruding members may allow easy integration of the OSA 102 with the metal housing (transceiver chassis) for ground connection by engaging (i.e., interlocking with) the metal housing 100. In other embodiments, the metal plate 104 and/or the protruding members may have other shapes and/or dimensions.

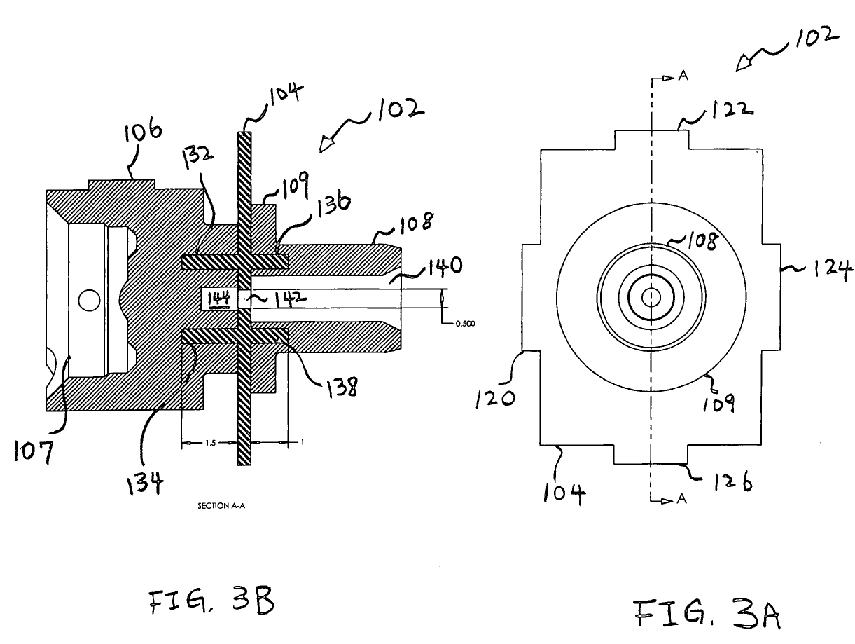

FIG. 3A is a front view of the OSA 102, and FIG. 3B is a cross-sectional view of the OSA 102 taken along the line A-A of FIG. 3A. It can be seen in FIG. 3B that the metal plate 104 has formed thereon pins 132 and 134 on its surface facing an OE device package 107. The metal plate 104 also has formed thereon pins 136 and 138 on its surface away from the OE device package 107. The pins 132 and 136 may be considered a single pin that traverses through the metal plate 104. In addition, the pins 134 and 138 may be considered a single pin that traverses through the metal plate 104. The metal plates in other embodiments may also have additional pins that traverse therethrough.

The pins 132 and 134 penetrate into the housing 106, and the pins 136 and 138 penetrate into the barrel 108 so that the housing 106, the metal plate 104 and the barrel 108 are fixedly coupled to one another. Hence, in a sense the metal plate 104 is embedded within the plastic barrel (package or housing) formed by the housing 106 and the barrel 108. In practice, the plastic barrel (including the housing 106 and the barrel 108) may be formed by over-molding plastic material on the metal plate 104 during injection molding.

The metal plate 104 has formed about its center a substantially circular opening (or an aperture) 142 that is aligned with the optical signal path between the housing 106 and the barrel 108. The barrel 108 has through its length a generally cylindrical cavity 140, through which an optical fiber (in a fiber ferrule), for example, is inserted to interface with the OE device package 107 within the housing 106. The opening 142 in the exemplary embodiment may have a diameter that is different than or equal to the diameter of a cavity 144 formed within the housing 106.

The metal plate 104 is positioned close to the focal point of the optical signal (e.g., laser beam) in the OSA barrel formed by the housing 106 and the barrel 108. The focal plane is often at the “stop” location for the fiber ferrule and is often referred to as the optical plane of the OSA barrel. When the metal plate 104 is close to the optical plane, the opening 142 can be made as small as possible (i.e., the size of the opening can be minimized) to provide better shielding for front EMI while still allowing the optical signal to pass substantially unobstructed.

When the metal shield has a shape other than that of a plate, the whole metal shield may not be aligned with the optical plane of the OSA barrel. In those cases, the opening for the optical signal should be positioned close to the focal point of the optical signal, so as to make the opening as small as possible (i.e., the size of the opening can be minimized)

The metal plate 104 may be used in either a TOSA or ROSA, and not necessarily both, of an optical transceiver. Further, the TOSA and ROSA barrels, multiple TOSA barrels, and/or multiple TOSA barrels may be coupled (e.g., electrically) together through respective metal plates formed therein. In an alternative embodiment, the OSA barrel (e.g., a plastic barrel) may be coated with metal, either completely or partially for EMI shielding.

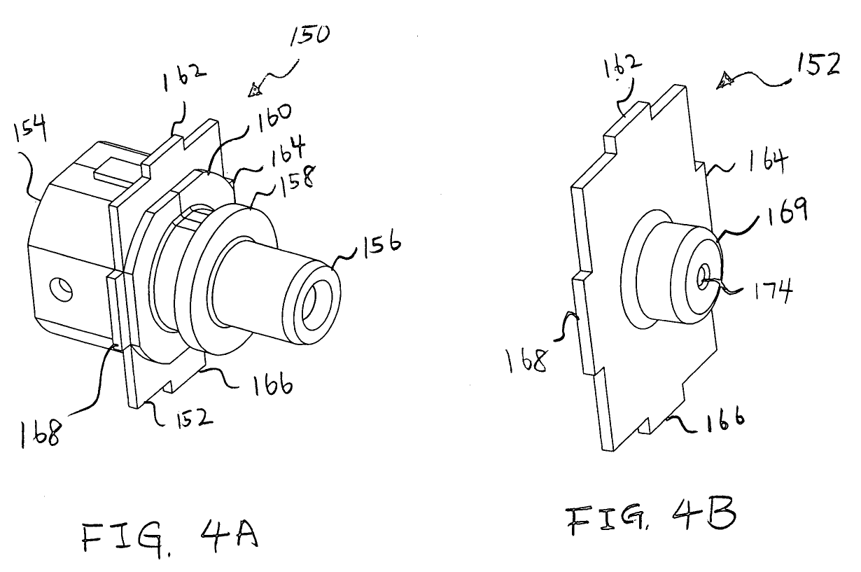

FIG. 4A is a perspective view of an OSA 150 (ROSA or TOSA) in an alternate exemplary embodiment in accordance with aspects of the present invention. When used, one or more of TOSAs and ROSAs of this type may be installed on a metal housing of the transceiver.

The OSA 150 includes a metal plate (or a metal insert) 152 disposed between a housing 154 and a barrel 156. An OE device package is disposed within the housing 154. Of course, the OE device package may be an optical transmitter or receiver depending on whether the OSA 150 is a TOSA or a ROSA. The barrel 156 has a flange 158 used to secure the OSA 150 on a metal housing, such as the metal housing 100 of FIG. 1. The metal plate 152 is held in place between the barrel 156 and the OSA housing 154. The barrel 156 is accessible from outside of a metal housing when mounted on the same. In the exemplary embodiment, the OSA housing 154 and the barrel 156 are formed from plastic. In other embodiments, the housing and barrel may be formed from other suitable materials. In still other embodiments, the OSA barrel may be made partly of metal and partly of plastic, wherein the metal portion of the OSA barrel serves as an EMI shield. Here, the metal portion of the OSA barrel may be referred to as a barrel, and the non-metal (e.g., plastic) part of the OSA barrel may be referred to as a housing.

FIG. 4B is a perspective view of the metal plate 152 of FIG. 4A. In the alternate exemplary embodiment, the metal plate 152 has a substantially rectangular shape, and has formed thereon a protruding member (i.e., a step) about the middle of each side (i.e., each edge) of the rectangle. Each of the protruding members 162, 164, 166 and 168 is substantially rectangular in shape, length of its longer side is approximately one third the length of the respective side from which it protrudes, and is substantially parallel to the respective side. One or more of the protruding members may allow easy integration of the OSA 152 with the metal housing (transceiver chassis) for ground connection by engaging (i.e., interlocking with) the metal housing. In other embodiments, the metal plate 152 and/or the protruding members may have other shapes and/or dimensions.

The metal plate 152 also has formed thereon a cylindrical member 169 about the center of the metal plate 152. The cylindrical member 169 has a generally circular surface 171 at the end away from the metal plate 152. The cylindrical member 169 has formed thereon a circular opening (or an aperture) 174 at the center of the generally circular surface 171. The cylindrical member 169, for example, may be formed by stamping a metal plate. When the cylindrical member has been formed using metal stamping, the cylindrical member is of a single integrated piece with the metal plate 152, and has a hollow interior with an opening to the hollow interior formed at the end close to the metal plate 152.

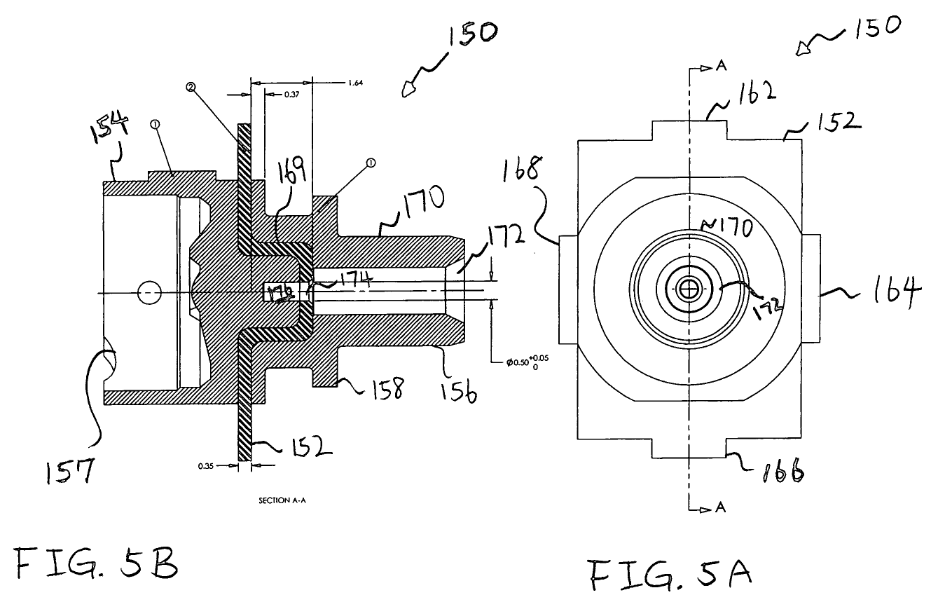

FIG. 5A is a front view of the OSA 150, and FIG. 5B is a cross-sectional view of the OSA 150 taken along the line A-A of FIG. 5A. It can be seen in FIG. 5B that the cylindrical member 169 of the metal plate 152 connects the OSA housing 154 with the barrel 156 formed by injection molding plastic.

The barrel 156 has through much of its length a generally cylindrical cavity 172, through which an optical fiber (in a fiber ferrule), for example, is inserted to interface with an OE device package 157 within the housing 154. The cylindrical member 169 of the metal plate 152 fits inside the barrel 156. This way, the OSA housing 154, metal plate 152 and the barrel 156 are fittably joined together. In practice, the plastic barrel (including the housing 154 and the barrel 156) may be formed by over-molding plastic material on the metal plate 152 during injection molding.

The circular opening 174 at the center of the cylindrical member 169 is aligned with the optical signal path between the OSA housing 154 and the barrel 156 during injection molding process. The opening 174 in the exemplary embodiment may have a diameter that is different than or equal to the diameter of a cavity 176 formed within the housing 154.

The circular opening 174 of the metal plate 152 is positioned close to the focal point of the optical signal (e.g., laser beam) in the OSA barrel formed by the housing 154 and the barrel 156. The focal plane often is at the “stop” location for the fiber ferrule and is often referred to as the optical plane of the OSA barrel. When the circular opening 174 is close to the optical plane, it can be made as small as possible (i.e., minimized) to provide better shielding for front EMI while still allowing the optical signal to pass substantially unobstructed.

The metal plate 152 may be used in either a TOSA or ROSA, and not necessarily both, of an optical transceiver. Further, the TOSA and ROSA barrels, multiple TOSA barrels, and/or multiple TOSA barrels may be coupled (e.g., electrically) together through respective metal plates formed therein. In an alternative embodiment, the OSA barrel may be coated with metal, either completely or partially for EMI shielding.

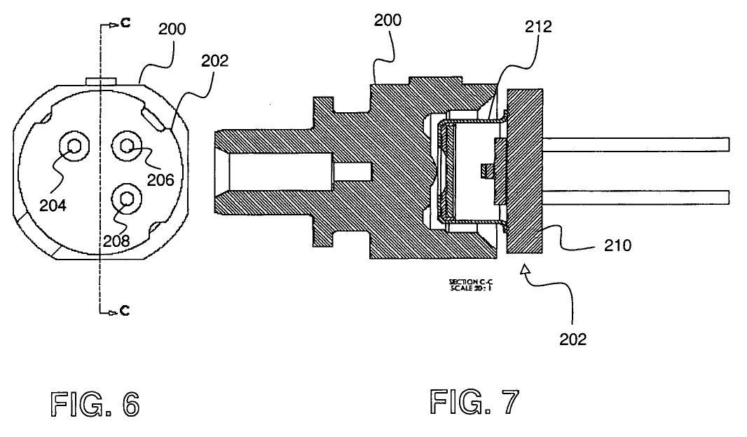

FIG. 6 is a rear view of a conventional TOSA 200, which has a standard transistor outline (TO) package 202 mounted thereon. The TO package 202 has formed thereon glass-sealed feed-throughs 204, 206 and 208 for carrying signals to and/or from the TO package 202. FIG. 7 is a cross-sectional view of the conventional TOSA 200 of FIG. 6 taken along the line C-C. The TO package 202 includes a TO header 210 welded with a TO cap 212. The TO header/cap is used as a signal ground. The TO can (including the TO header 210 and the TO cap 212) is not coupled to the chassis ground (e.g., the metal housing 100 of FIG. 1). Therefore, the TO can does not provide sufficient shielding protection against side EMI.

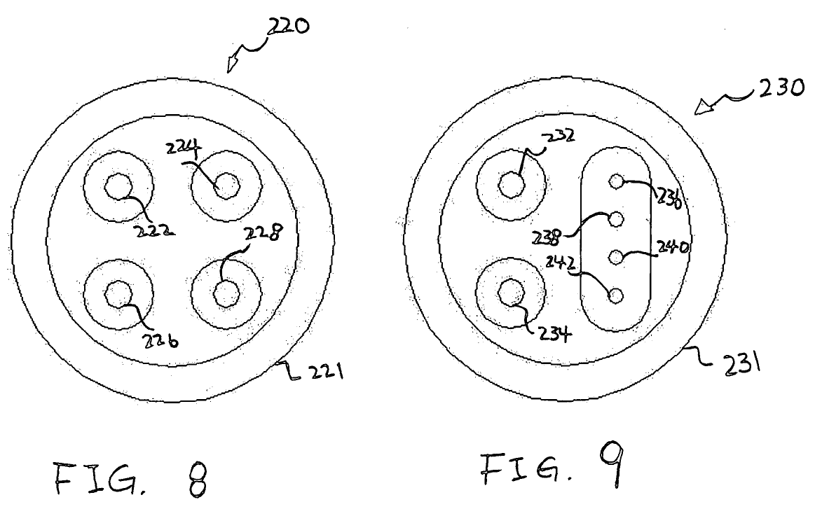

This is also the case for a standard TO-46 package 220, rear view of which is illustrated on FIG. 8. The TO package 220 has formed thereon glass-sealed feed-throughs 222, 224, 226 and 228 for carrying signals to and/or from the TO package 220. The signal ground in the TO package 220 is provided by a TO header 221 welded to a TO cap.

As seen on FIG. 8, the number of feed-throughs is usually limited to a maximum of four. This typically is not enough for today's multi-GHz transceivers, especially on the receiver side. To conserve connections, the signal grounds are usually connected to the header 221. This makes the packages susceptible to side EMI coupled through the signal ground within the transceiver.

In an exemplary embodiment in accordance with the aspects of the present invention as illustrated in FIG. 9, a TO package 230 includes glass filled feed-throughs 232 and 234. The TO package 230 acts as a mechanical, optical and electrical platform for the active and passive components within the optical subassemblies (OSAs). The windowed “can” provides a hermetic environment for the components, and the electrical connections are made through the glass-sealed feed-throughs on the TO header 231.

The TO package 230 also includes an elongated (e.g., oblong shape) glass filled feed-through that has embedded therein four in-line pins (or lead frames) 236, 238, 240 and 242. Hence, instead of using the TO header 231 and/or the TO cap as the signal ground, one or more of the in-line pins 236, 238, 240 and 242 can be used to make contact with the PCB circuit ground as the signal ground. The number of in-line pins in other embodiments may vary (for example, 3 or 5).

None of the in-line pins is directly connected to the TO case, and form a coplanar GSG (ground-signal-ground, e.g., a three in-line pin configuration) or GSSG (ground-signal-signal-ground, e.g., a four in-line pin configuration) transmission line through the header 231. The TO case (including header and cap) is electrically connected to the transceiver housing (e.g., a chassis ground). In this way, the internal components are shielded from the side EMI.

In an alternate embodiment, a similar scheme is used with a ceramic header by providing the suitable metalization on the header. By way of example, the metalization of the header may be provided by metal plating an external circumferential periphery of the header. Here glass-sealed feed-throughs are replaced by electrical vias through the ceramic. Together with the metal plate for shielding front EMI described above, the shielding provides effective EMI suppression when using low-cost plastic barrels for optical subassemblies.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof are intended to be embraced therein.

We claim:

1. In an optical transceiver and/or receiver for converting and coupling an information-containing electrical signal with an optical fiber, an opto-electronic subassembly comprising
a housing including an optical fiber connector adapted for coupling with an external optical fiber for transmitting and/or receiving an optical communications signal;
an opto-electronic device in the housing for converting between an information-containing electrical signal and modulated optical signal corresponding to the electrical signal; and
a Faraday shield for minimizing electromagnetic interference entering or leaving the opto-electronic device, extending adjacent to and around the portion of the connector adapted to couple to the periphery of the optical fiber.

2. An optical transmitter and/or receiver as defined in claim 1 wherein the housing is a barrel for supporting and aligning the opto-electronic device with the connector.

3. An optical transmitter and/or receiver as defined in claim 1 wherein the Faraday Shield is formed by a metallic portion of the housing.

4. An optical transmitter and/or receiver as defined in claim 1 wherein the Faraday Shield includes a metal layer embedded within the housing.

5. An optical transmitter and/or receiver as defined in claim 1 wherein the Faraday Shield is a metallic coating on a surface of the housing.

6. An optical transmitter and/or receiver as defined in claim 1 wherein the Faraday Shield is connected to a chassis ground of the transmitter and/or receiver.

7. An optical transmitter and/or receiver as defined in claim 2 wherein the barrel includes a metal plate that has a generally cylindrical protrusion formed thereon, an aperture is substantially aligned with a center axis of the cylindrical protrusion so that an external surface of the cylindrical protrusion engages the barrel.

8. An optical subassembly (OSA) comprising:
an opto-electronic (OE) device;
a support for optically aligning the OE device with an external optical fiber; and
a metal shield disposed between the OE device and the support so as to minimize the electromagnetic interference (EMI) between the OSA and adjacent electronic circuitry.

9. The OSA of claim 8, wherein the metal shield is a metal plate having the aperture formed there through for allowing an optical beam to pass there through to or from the OE device.

10. The OSA of claim 8, further comprising a non-metal housing for holding the OE device, wherein the metal shield forms a portion of the support.

11. The OSA of claim 8, wherein the OE support is a metal barrel, and has at least one pin for electrically connecting a signal ground of the OE device to the chassis ground.

12. The OSA of claim 11, wherein said pin is embedded in a glass filled feed-through formed through a header of the metal barrel.

13. The OSA of claim 16, wherein the metal barrel includes a metalized ceramic header, and wherein said pin is electrically connected to an electrical via formed through the metalized ceramic header.

14. The OSA of claim 8, wherein the OE device is a laser.

15. An optical subassembly (OSA) comprising:
an opto-electronic (OE) device;
a barrel for optically aligning the OE device with an external device; and
a metal shield disposed between the OE device and the barrel so as to reduce front electromagnetic interference (EMI) of the OSA, the metal shield having an aperture for allowing an optical signal to pass through,
wherein the aperture is positioned proximately to a focal point of the optical signal, so that the size of the aperture can be minimized.

16. The OSA of claim 15, wherein the metal shield is a metal plate having the aperture formed therethrough.

17. The OSA of claim 16, further comprising a housing for holding the OE device, wherein the metal plate has a plurality of pins formed thereon for engaging the housing and the barrel.

18. The OSA of claim 16, wherein the metal plate has a plurality of protruding members formed around its periphery for engaging a transceiver housing.

19. The OSA of claim 15, further comprising a non-metal housing for holding the OE device, wherein the metal shield is a barrel portion that is integrated with the barrel, which is made of metal, and wherein the non-metal housing, the barrel portion and the barrel form a hybrid barrel.

20. The OSA of claim 16, further comprising a housing for holding the OE device, wherein the metal plate has a generally cylindrical protrusion formed thereon, wherein the aperture is substantially aligned with a center axis of the cylindrical protrusion, and wherein an external surface of the cylindrical protrusion engages the barrel and an internal surface of the cylindrical protrusion engages the housing.

21. An optical transceiver comprising:
a metal housing; and
an optical subassembly (OSA) mounted in the metal housing, the OSA comprising:
an opto-electronic (OE) device;
a barrel for optically aligning the OE device with an external device; and
a metal shield disposed between the OE device and the barrel so as to reduce front electromagnetic interference (EMI) of the OSA, the metal shield having an aperture for allowing an optical beam to pass through.

22. The optical transceiver of claim 21, wherein the metal shield is a metal plate having the aperture formed therethrough.

23. The optical transceiver of claim 21, wherein the metal case comprises a metalized ceramic header, and wherein said at least one pin is electrically connected to at least one electrical via formed through the metalized ceramic header.

24. The optical transceiver of claim 21, wherein the second OE device is a laser.

25. An optical transceiver comprising:
a metal housing;
an optical subassembly (OSA) in the housing including an opto-electronic (OE) package having an OE device and a metal case surrounding at least a portion of the OE device;
a printed circuit board (PCB) in the housing and having a PCB ground; and
wherein the metal case is electrically grounded to the metal housing, so as to reduce electromagnetic interference (EMI.

26. The optical transceiver of claim 25, wherein the OE package has at least one pin for electrically connecting a signal ground of the OE device to the PCB ground.

27. The optical transceiver of claim 26, wherein said at least one pin is embedded in a glass filled feed-through formed through a header of the metal case.

28. The optical transceiver of claim 25, wherein the metal case includes a metalized ceramic header, and wherein said at least one pin is electrically connected to at least one electrical via formed through the metalized ceramic header.
